(19) United States
(12) Patent Application Publication
(10) Pub. No.: US 2014/0085625 A1
(43) Pub. Date: Mar. 27, 2014

(54) SKIN AND OTHER SURFACE CLASSIFICATION USING ALBEDO

(71) Applicants: Abdelrehim Ahmed, Santa Clara, CA (US); Britta Hummel, Berkeley, CA (US); Travis Perry, Menlo Park, CA (US); Vishali Mogallapu, Los Gatos, CA (US)

(72) Inventors: Abdelrehim Ahmed, Santa Clara, CA (US); Britta Hummel, Berkeley, CA (US); Travis Perry, Menlo Park, CA (US); Vishali Mogallapu, Los Gatos, CA (US)

(21) Appl. No.: 13/627,809

(22) Filed: Sep. 26, 2012

(51) Int. Cl. G01N 21/55; G01B 11/24

(52) U.S. Cl. 356/73

(57) ABSTRACT

A system and method are disclosed relating to a pipeline for generating a computer model of a target user, including a hand model of the user's hands and fingers, captured by an image sensor in a NUI system. The computer model represents a best estimate of the position and orientation of a user's hand or hands. The generated hand model may be used by a gaming or other application to determine such things as user gestures and control actions.

### BACKGROUND

In the past, computing applications such as computer games and multimedia applications used controllers, remotes, keyboards, mice, or the like to allow users to manipulate game characters or other aspects of an application. More recently, computer games and multimedia applications have begun employing cameras and software gesture recognition engines to provide a natural user interface (“NUI”). With NUI, raw joint data and user gestures are detected, interpreted and used to control game characters or other aspects of an application.

One of the challenges of a NUI system is distinguishing a person in the field of view of an image sensor, and correctly identifying body parts including hands and fingers within the field of view. Routines are known for tracking arms, legs, head and torso. However, given the wide variety of positions of a user's hands, and that they are often proximate to or interacting with other objects, it is often difficult to recognize and track a user's body including finger and hand positions.

### SUMMARY

Disclosed in embodiments herein are systems and methods for recognizing skin so as to allow identification of body parts such as a user's face, hands and fingers. A highly discriminative feature to visually classify material types, such as the skin of a user's hand and face, is their surface reflectivity, also known as albedo. A material's albedo is defined as the ratio of reflected radiation to incoming radiation. By determining the albedo of surfaces captured by an image capture device, and comparing the determined albedo to the known albedo values for skin, the present technology may be used to identify and track body parts with exposed skin such as a user's face, hands and fingers. Moreover, while embodiments of the present technology are described with respect to identifying skin, further embodiments may be used to identify other materials captured by an image capture device by determining albedo of the material and comparing the determined albedo to known values of such other materials.

In examples, the identification and tracking of hand and finger positions according to the present technology may be used by NUI systems for triggering events such as selecting, engaging, or grabbing and dragging objects on a screen or in a mixed reality environment. A variety of other gestures, control actions and applications may be enabled by the present technology. By identification of a user's face, hand and fingers, interactivity of a user with an NUI system may be increased, and simpler and more intuitive interfaces may be presented to a user.

In one example, the present disclosure relates to a method for identifying a surface material, comprising: (a) capturing position data representing a three dimensional depth map of the surface material; (b) measuring an amount of light incident on the surface material; and (c) determining albedo values, from the data captured in said step (a) and light measured in said step (b), at points on the surface material for comparison against known albedo values to identify the surface material.

In a further example, the present disclosure relates to a method for identifying whether a surface material is human skin, comprising: (a) capturing an image of a field of view including the surface material; (b) generating a depth map from the captured field of view, the depth map including three-dimensional coordinates of points on the surface material; (c) determining an amount of light incident on the surface material; (d) determining albedo values at points on the surface material from the depth map generated in said step (b) and the amount of incident light determined in said step (c); (e) comparing the albedo values determined in said step (d) against a range of known albedo values for human skin; and (f) drawing an inference as to whether the surface material is human skin based at least in part on a number of points on the surface material having albedo values within the range of albedo values for human skin.

In a further example, the present disclosure relates to one or more processor readable storage devices having processor readable code embodied on said processor readable storage devices, said processor readable code for programming one or more processors to perform a method for identifying whether a surface material is a target material, comprising: (a) capturing an image from of a field of view including the surface material; (b) generating a depth map from the captured field of view, the depth map including three-dimensional coordinates of points on the surface material; (c) determining an amount of light incident on the surface material; (d) determining albedo values at points on the surface material from the depth map generated in said step (b) and the amount of incident light determined in said step (c); and (e) applying classification criteria to the points on the surface material for which albedo values have been determined in said step (d), the classification criteria returning an indication that: i) it is undetermined whether the points on the surface material are the target material, ii) it is determined that the points on the surface material are not the target material, or iii) it is inferred that the points on the surface are the target material.

This Summary is provided to introduce a selection of concepts in a simplified form that are further described below in the Detailed Description.. This Summary is not intended to identify key features or essential features of the claimed subject matter, nor is it intended to be used as an aid in determining the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1A illustrates an example embodiment of a target recognition, analysis, and tracking system.

FIG. 1B illustrates a further example embodiment of a target recognition, analysis, and tracking system.

FIG. 1C illustrates a still further example embodiment of a target recognition, analysis, and tracking system.

FIG. 2 illustrates an example embodiment of a capture device that may be used in a target recognition, analysis, and tracking system.

FIG. 3 is a flowchart of the overall operation of the present disclosure for measuring albedo values of a surface material.

FIG. 4 is an illustration of light from a light component striking a surface and reflecting back to an image capture device including the light component.

FIG. 5 is a flowchart of an embodiment for calibrating a light component using a calibration pattern.

FIG. 6 is an illustration of a sample light source profile which may be obtained from imaging a calibration pattern.

FIG. 7 is an illustration an embodiment for determining whether a surface material in the field of view is a target material such as skin using albedo values.

FIG. 8 is a flowchart for teaching a system the albedo skin values for a particular person.

FIG. 9A illustrates an example embodiment of a computing environment that may be used to interpret one or more gestures in a target recognition, analysis, and tracking system.

FIG. 9B illustrates another example embodiment of a computing environment that may be used to interpret one or more gestures in a target recognition, analysis, and tracking system.

### DETAILED DESCRIPTION

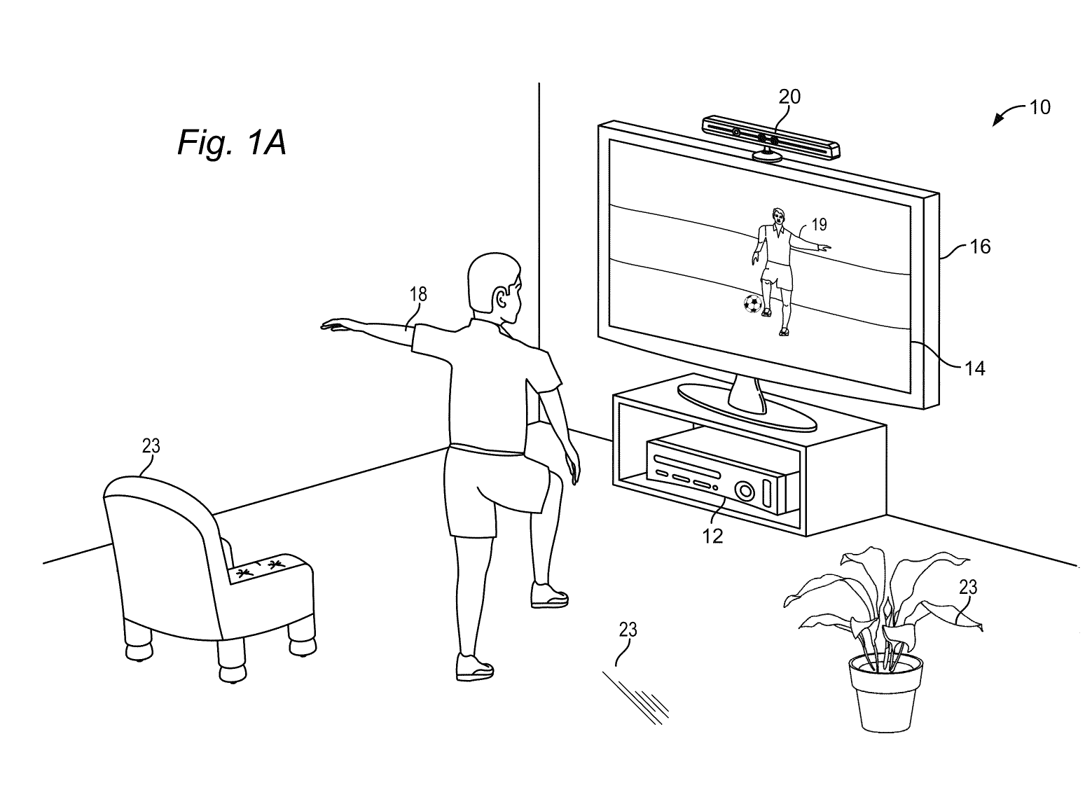

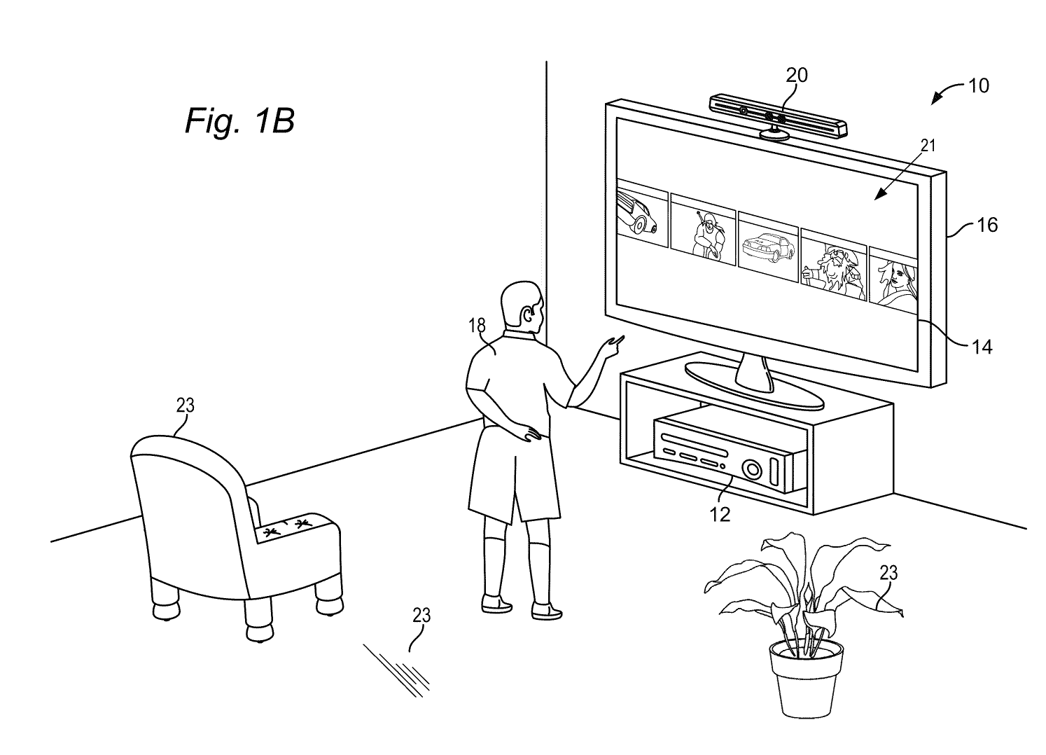

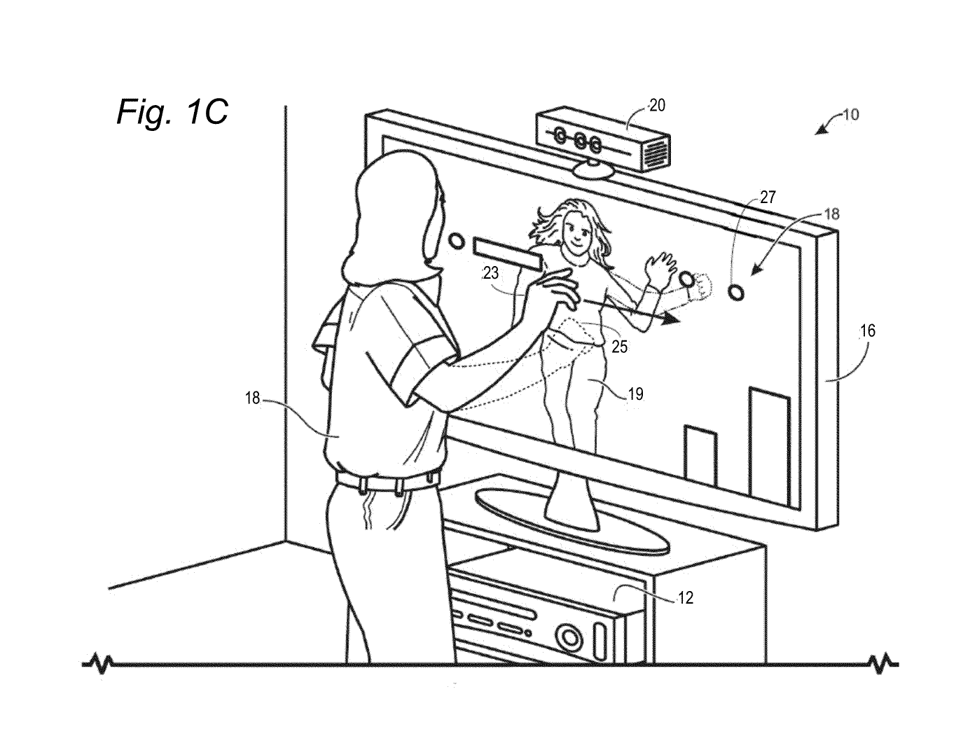

Embodiments of the present technology will now be described with reference to FIGS. 1A-9B, which in general relate to a system for classifying a surface material captured by an image capture device by determining an albedo of the surface material and comparing the determined albedo to -known albedo values for the surface material. In examples, the surface material may be skin, such as on a user's hands or face, but it may be other materials in further embodiments.

In one example, the present technology provides a system for estimating material albedo from an infrared image capture device such as a time-of-flight (TOF) camera. The TOF camera provides a depth map of a captured scene, including the X, Y, Z coordinates of objects and surfaces within the scene. The TOF camera also allows the determination of an active brightness value. Using these parameters, albedo values for groups of pixels may be determined. If a threshold number of pixels in the group have albedo values within a range of a given material, such as skin, the assumption may be made that the material is positively identified.

The classification of captured surfaces as skin or otherwise may take place once per frame of captured image data, though it may be more or less frequent than that in further embodiments. In one example explained below, by identifying materials as skin and in particular, a user's hands, the generated hand model may be used by a gaming or other application to determine such things as user gestures and control actions. It is understood that the present technology may be used to identify materials for purposes other than for use in a gaming or other application.

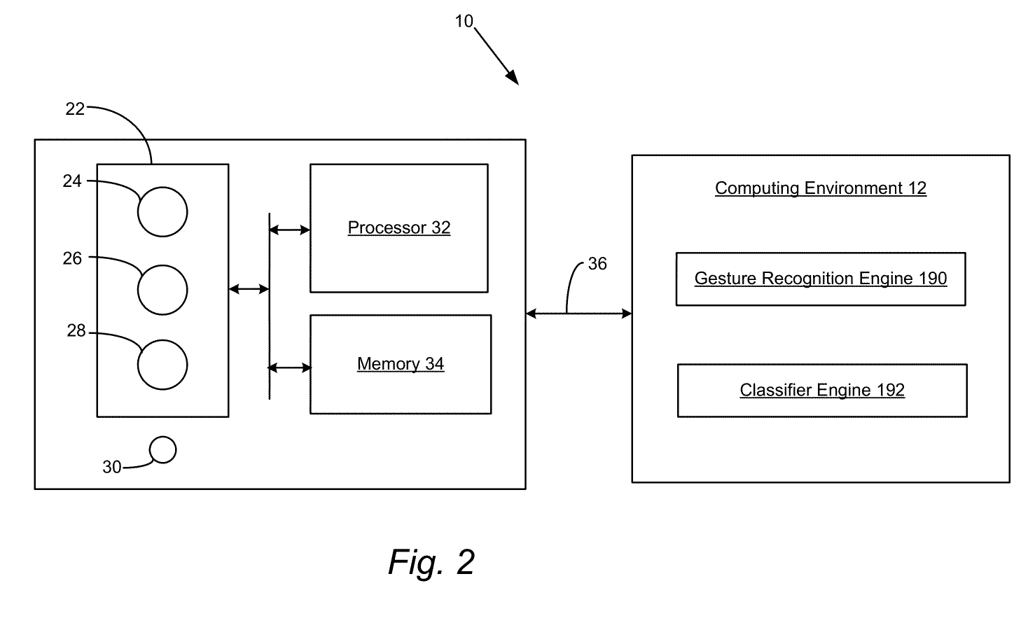

Referring initially to FIGS. 1A-2, the hardware for implementing the present technology includes a target recognition, analysis, and tracking system 10 which may be used to recognize, analyze, and/or track a human target such as the user 18. Embodiments of the target recognition, analysis, and tracking system 10 include a computing environment 12 for executing a gaming or other application. The computing environment 12 may include hardware components and/or software components such that computing environment 12 may be used to execute applications such as gaming and non-gaming applications. In one embodiment, computing environment 12 may include a processor such as a standardized processor, a specialized processor, a microprocessor, or the like that may execute instructions stored on a processor readable storage device for performing processes described herein.

The system 10 further includes a capture device 20 for capturing image and audio data relating to one or more users and/or objects sensed by the capture device. In embodiments, the capture device 20 may be used to capture information relating to body and hand movements and/or gestures and speech of one or more users, which information is received by the computing environment and used to render, interact with and/or control aspects of a gaming or other application. Examples of the computing environment 12 and capture device 20 are explained in greater detail below.

Embodiments of the target recognition, analysis and tracking system 10 may be connected to an audio/visual (A/V) device 16 having a display 14. The device 16 may for example be a television, a phone, a monitor for a computer, a high-definition television (HDTV), or the like that may provide game or application visuals and/or audio to a user. For example, the computing environment 12 may include a video adapter such as a graphics card and/or an audio adapter such as a sound card that may provide audio/visual signals associated with the game or other application. The A/V device 16 may receive the audio/visual signals from the computing environment 12 and may then output the game or application visuals and/or audio associated with the audio/visual signals to the user 18. According to one embodiment, the audio/visual device 16 may be connected to the computing environment 12 via, for example, an S-Video cable, a coaxial cable, an HDMI cable, a DVI cable, a VGA cable, a component video cable, or the like.

In embodiments, the computing environment 12, the A/V device 16 and the capture device 20 may cooperate to render an avatar or on-screen character 19 on display 14. For example, FIG. 1A shows a user 18 playing a soccer gaming application. The user's movements are tracked and used to animate the movements of the avatar 19. In embodiments, the avatar 19 mimics the movements of the user 18 in real world space so that the user 18 may perform movements and gestures which control the movements and actions of the avatar 19 on the display 14.

As explained above, motion estimation routines such as skeleton mapping systems may lack the ability to detect subtle gestures of a user, such as for example the movement of a user's hand. For example, a user may wish to interact with NUI system 10 by scrolling through and controlling a user interface 21 with his hand as shown in FIG. 1B. A user may alternatively attempt to perform various gestures, such as for example by opening and/or closing her hand as shown at 23 and 25 in FIG. 1C.

Accordingly, example systems and methods, described below, are directed to identifying a hand of a user. For example, the action of closing and opening the hand may be used by such systems for triggering events such as selecting, engaging, or grabbing and dragging objects, e.g., object 27 (FIG. 1C), on the screen. These actions otherwise would correspond to pressing a button when using a controller. Such refined controller-free interaction can be used as an alternative to approaches based on hand waving or hovering, which may be unintuitive or cumbersome. A variety of other gestures, control actions and applications may be enabled by the present technology for recognizing and tracking hand motions, some of which are described in further detail below. By identifying and determining states of a user's hand as described below, interactivity of a user with the system may be increased and simpler and more intuitive interfaces may be presented to a user.

FIGS. 1A-1B include static, background objects 23, such as a floor, chair and plant. These are objects within the field of view (FOV) captured by capture device 20, but do not change from frame to frame. In addition to the floor, chair and plant shown, static objects may be any objects picked up by the image cameras in capture device 20. The additional static objects within the scene may include any walls, ceiling, windows, doors, wall decorations, etc.

Suitable examples of a system 10 and components thereof are found in the following co-pending patent applications, all of which are hereby specifically incorporated by reference: U.S. patent application Ser. No. 12/475,094, entitled “Environment and/or Target Segmentation,” filed May 29, 2009; U.S. patent application Ser. No. 12/511,850, entitled “Auto Generating a Visual Representation,” filed Jul. 29, 2009; U.S. patent application Ser. No. 12/474,655, entitled “Gesture Tool,” filed May 29, 2009; U.S. patent application Ser. No. 12/603,437, entitled “Pose Tracking Pipeline,” filed Oct. 21, 2009; U.S. patent application Ser. No. 12/475,308, entitled “Device for Identifying and Tracking Multiple Humans Over Time,” filed May 29, 2009, U.S. patent application Ser. No. 12/575,388, entitled “Human Tracking System,” filed Oct. 7, 2009; U.S. patent application Ser. No. 12/422,661, entitled “Gesture Recognizer System Architecture,” filed Apr. 13, 2009; and U.S. patent application Ser. No. 12/391,150, entitled “Standard Gestures,” filed Feb. 23, 2009.

FIG. 2 illustrates an example embodiment of the capture device 20 that may be used in the target recognition, analysis, and tracking system 10. In an example embodiment, the capture device 20 may be configured to capture video having a depth image that may include depth values via any suitable technique including, for example, time-of-flight, structured light, stereo image, or the like. According to one embodiment, the capture device 20 may organize the calculated depth information into “Z layers,” or layers that may be perpendicular to a Z axis extending from the depth camera along its line of sight. X and Y axes may be defined as being perpendicular to the Z axis. The Y axis may be vertical and the X axis may be horizontal. Together, the X, Y and Z axes define the 3-D real world space captured by capture device 20. In embodiments, a position of the capture device 20 may arbitrarily set to coordinates (0, 0, 0) within the real world space, but it is understood that the capture device may be positioned at other coordinates within the real world space.

As shown in FIG. 2, the capture device 20 may include an image camera component 22. According to an example embodiment, the image camera component 22 may be a depth camera that may capture the depth image of a scene. The depth image may include a two-dimensional (2-D) pixel area of the captured scene where each pixel in the 2-D pixel area may represent a depth value such as a length or distance in, for example, centimeters, millimeters, or the like of an object in the captured scene from the camera. As explained below, determination of the depth value at a point on a surface of an object also enables the determination of a normal vector to that surface at that point.

As shown in FIG. 2, according to an example embodiment, the image camera component 22 may include an IR light component 24, a three-dimensional (3-D) camera 26, and an RGB camera 28 that may be used to capture the depth image of a scene. For example, in time-of-flight analysis, the IR light component 24 of the capture device 20 may emit an infrared light onto the scene and may then use sensors (not shown) to detect the backscattered light from the surface of one or more targets and objects in the scene using, for example, the 3-D camera 26 and/or the RGB camera 28. As explain below, there may be a single or multiple IR light components 24 in different embodiments.

In some embodiments, pulsed infrared light may be used such that the time between an outgoing light pulse and a corresponding incoming light pulse may be measured and used to determine a physical distance from the capture device 20 to a particular location on the targets or objects in the scene. Additionally, in other example embodiments, the phase of the outgoing light wave may be compared to the phase of the incoming light wave to determine a phase shift. The phase shift may then be used to determine a physical distance from the capture device 20 to a particular location on the targets or objects.

According to another example embodiment, time-of-flight analysis may be used to indirectly determine a physical distance from the capture device 20 to a particular location on the targets or objects by analyzing the intensity of the reflected beam of light over time via various techniques including, for example, shuttered light pulse imaging.

In another example embodiment, the capture device 20 may use a structured light to capture depth information. In such an analysis, patterned light (i.e., light displayed as a known pattern such as a grid pattern or a stripe pattern) may be projected onto the scene via, for example, the a light component 24. Upon striking the surface of one or more targets or objects in the scene, the pattern may become deformed in response. Such a deformation of the pattern may be captured by, for example, the 3-D camera 26 and/or the RGB camera 28 and may then be analyzed to determine a physical distance from the capture device 20 to a particular location on the targets or objects.

According to another embodiment, the capture device 20 may include two or more physically separated cameras that may view a scene from different angles, to obtain visual stereo data that may be resolved to generate depth information. In another example embodiment, the capture device 20 may use point cloud data and target digitization techniques to detect features of the user. Other sensor systems may be used in further embodiments.

The capture device 20 may further include a microphone 30. The microphone 30 may include a transducer or sensor that may receive and convert sound into an electrical signal. According to one embodiment, the microphone 30 may be used to reduce feedback between the capture device 20 and the computing environment 12 in the target recognition, analysis, and tracking system 10. Additionally, the microphone 30 may be used to receive audio signals that may also be provided by the user to control applications such as game applications, non-game applications, or the like that may be executed by the computing environment 12.

In an example embodiment, the capture device 20 may further include a processor 32 that may be in operative communication with the image camera component 22. The processor 32 may include a standardized processor, a specialized processor, a microprocessor, or the like that may execute instructions that may include instructions for receiving the depth image, determining whether a suitable target may be included in the depth image, converting the suitable target into a skeletal representation or model of the target, or any other suitable instruction.

The capture device 20 may further include a memory component 34 that may store the instructions that may be executed by the processor 32, images or frames of images captured by the 3-D camera or RGB camera, or any other suitable information, images, or the like. According to an example embodiment, the memory component 34 may include random access memory (RAM), read only memory (ROM), cache, Flash memory, a hard disk, or any other suitable storage component. As shown in FIG. 2, in one embodiment, the memory component 34 may be a separate component in communication with the image camera component 22 and the processor 32. According to another embodiment, the memory component 34 may be integrated into the processor 32 and/or the image camera component 22.

As shown in FIG. 2, the capture device 20 may be in communication with the computing environment 12 via a communication link 36. The communication link 36 may be a wired connection including, for example, a USB connection, a Firewire connection, an Ethernet cable connection, or the like and/or a wireless connection such as a wireless 802.11b, g, a, or n connection. According to one embodiment, the computing environment 12 may provide a clock to the capture device 20 that may be used to determine when to capture, for example, a scene via the communication link 36.

Additionally, the capture device 20 may provide the depth information and images captured by, for example, the 3-D camera 26 and/or the RGB camera 28. With the aid of these devices, a partial skeletal model may be developed, with the resulting data provided to the computing environment 12 via the communication link 36.

The computing environment 12 may further include a gesture recognition engine 190 for recognizing gestures. In accordance with the present system, the computing environment 12 may further include a classifier engine 192, which software engine is described in greater detail below.

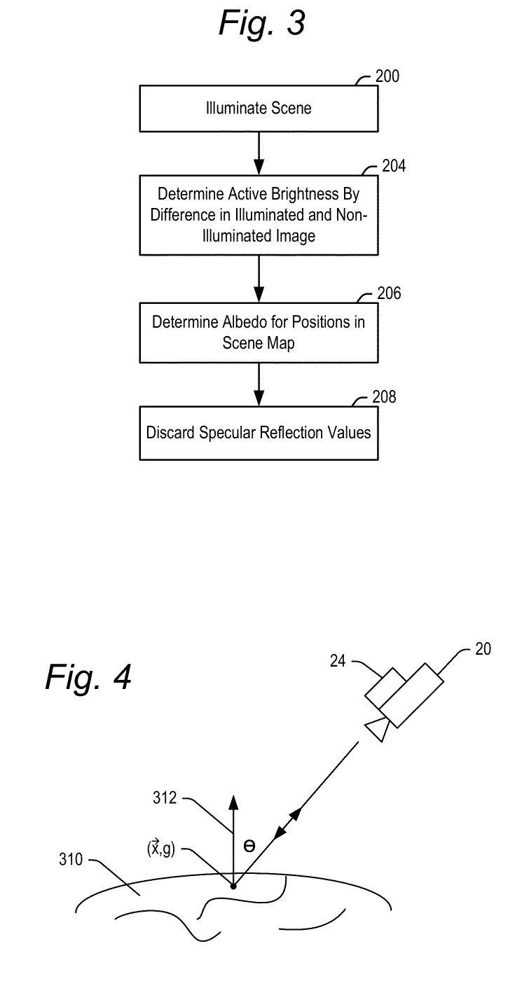

Examples of the present technology will now be explained with reference to FIGS. 3-8. In one aspect of the present technology, the classifier engine 192 computes surface albedo of pixels in a scene, given each pixel's 3-D position in the scene and its active brightness (defined below). Referring to the flowchart of FIG. 3 and the illustration of FIG. 4, this process may start in step 200 by the one or more IR light components 24 of capture device 20 illuminating a scene to enable computation of the distance to scene points, and obtain the 3-D scene map.

In step 204, the classifier engine 192 may then determine an active brightness image. An active brightness image may be determined by taking the difference between a first illuminated image and a second non-illuminated image. An illuminated image includes light from the one or more IR light components 24. The non-illuminated image is obtained by turning off (or otherwise negating) the one or more IR light components 24. Any light in the image at that point detected by capture device 20 is due to ambient light or other sources apart from an IR light component 24. Each pixel in the scene map point cloud may be defined as a 4-tuple (\vec{x}, g), consisting of a 3-D point x having an (x,y,z) coordinate, and an active brightness value g. The brightness value g is a measurement that is proportional to the modulated light received by the sensor, and may be the light measured in the pixel resulting from the IR light source alone.

With the scene map point cloud, the albedo of a surface 310 at position \vec{x} may be modeled as a function of the active brightness value at that position. In step 206, a Lambertian reflectance model may be used to determine albedo at positions \vec{x} in the scene map as a function of the active brightness value, g:

g=ρ·(B·cosθ+A), where (1)

B: Strength of incident light

ρ: Albedo

θ: Angle between incident light and surface normal 312 at \vec{x}

A: Ambient light.

Values for active brightness may be normalized to lie in the interval [0,1], though it may be expressed in other forms in further embodiments.

In order to calculate the angle θ between incident light and surface normal 312, the surface normal is taken at position \vec{x}. The surface normal 312 may be computed at each point from the point cloud image data obtained by the capture device. The directed incident light stems from the IR light component 24. In this embodiment, one IR light source is used, and it is assumed to be positioned at an optical center of a CCD/CMOS sensor chip in the capture device 20 for capturing image data of the point cloud. Thus, the incident light vector may be assumed equal to the vector (x, y, z) measuring the position \vec{x}.

The position of the capture device 20 and IR light component 24 are known in the 3-D map of the scene, and may be positioned at (0, 0, 0) within the scene. A position different than the position of the capture device 20 and IR light component 24 may be selected as the origin in further embodiments, in which event vector subtraction may be used to define the vector of the light from the IR light component 24 to the position \vec{x}. As explained below, further embodiments may operate using two or more IR light components 24, each spaced from the sensor chip in the capture device 20.

In the above equation (1), A may be equal to 0, as the active brightness image is the difference image between the illuminated and the non-illuminated scene. Thus, the ambient light term A may be omitted.

The strength of the incident light B in equation (1) may decrease quadratically. Thus:

$$B = \frac{c}{{r}^{2}} , \\ where \qquad ( 2 )$$

r=radial distance provided by the depth camera as r=∥\vec{x}∥=\sqrt{x²+y²+z²}, and
c=strength of emitted light.
   The value for c is a camera hardware constant for an IR light component 24, and may be calibrated as explained below.

Combining equations (1) and (2) yields a pixel's surface albedo given its 3-D position and active brightness:

$$ρ = \frac{( {x}^{2} + {y}^{2} + {z}^{2} ) \cdot g}{c \cdot cos θ} \qquad ( 3 )$$

A Lambertian reflectance model is appropriate under diffuse reflection, but may not be under specular reflection. Smooth, “mirror”-like surfaces exhibit more specular reflection than rough ones. Human skin is usually rough enough to avoid specular reflection in visible light. However, specular reflection may occur if the angle θ between the surface normal and the incident light is close to zero. As such, in step 208, albedo values for pixels with a small angle θ (for example θₘᵢₙ=5 degrees) may be discarded. It is understood that the minimum angle may be greater than or less than 5 degrees in further embodiments.

In the above example, calculations were set forth for a system including a single IR light component 24 positioned at the optical center of the capture device 20 sensor. In further embodiments, multiple IR light components 24 may be used, each spaced from an optical center of the capture device 20 sensor. In one example, there may be between two and eight light components 24, each spaced 3-5 cm distance from the optical center, though the number of light components may be more than this, and they may be spaced a greater or lesser distance from the optical center in further embodiments.

In this embodiment, the image brightness may be modeled from n independent light sources (IR light components 24), having a mounting position relative to the capture device's optical center provided as calibration parameters \vec{l}₁, . . . , \vec{l}ₙ. The following equation (4) applies the Lambertian law from equation 1 to the case of n directed light sources:

$$g = ρ \cdot ( A + {\sum }_{i = 1}^{n} {B}_{i} \cdot cos {θ}_{i} ) , \\ where \qquad ( 4 )$$

θᵢ is the angle between incident light from light source i and the scene point's surface normal,

Bᵢ is the strength of incident light stemming from light source i. Bᵢ may be computed analogously to equation (2):

$$B = \frac{{c}_{i}}{{r}_{i}^{2}} , \\ where \qquad ( 5 )$$

rᵢ is the radial distance from light source i to scene point:

rᵢ=∥\vec{x}−\vec{l}ᵢ∥=\sqrt{(x−l_{x,i})²+(y−l_{y,i})²+(z−l_{z,i})²}; and (6)

cᵢ is the strength of emitted light from light source i, and may be calibrated as explained below.

Combining equations (4)-(6) yields the generalization of equation (3) to multiple light sources:

$$ρ = g \cdot {( {\sum }_{i = 1}^{n} \frac{{c}_{i} \cdot cos {θ}_{i}}{{‖ {x}^{->} - {{l}^{->}}_{l} ‖}^{2}} )}^{- 1} , \qquad ( 7 )$$

As explained above, one parameter used in the determination of albedo values for objects captured in a scene is the camera constant cᵢ for each IR light component 24 used in the capture of the scene. The camera constant cᵢ represents the amount of light emitted from the i^{th} IR light component 24. The intensity and beam width from the one or more IR light components 24 may vary with the spherical angle of the emitted light ray: cᵢ(θ, φ). cᵢ(θ, φ) may be referred to herein as the light source profile. Due to manufacturing tolerances it may be calibrated prior to albedo determination for points in a scene.

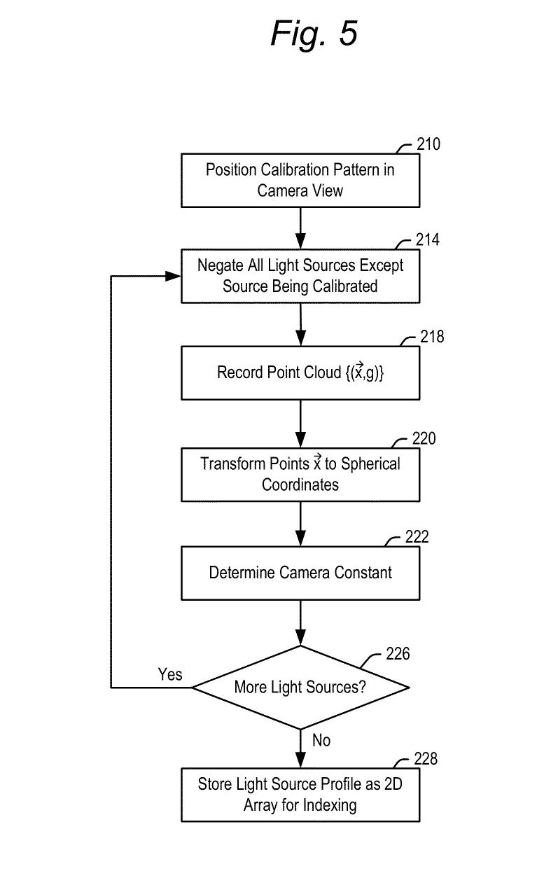

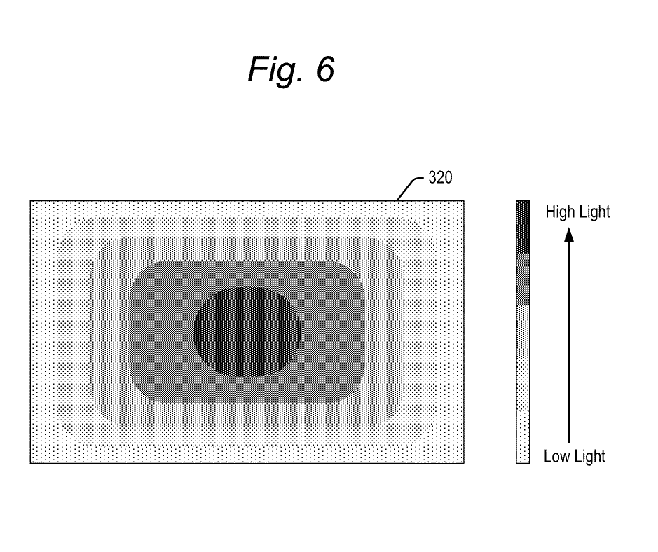

The light source profile calibration may be performed during the IR light component 24 manufacturing process, though it may be performed by an end user in further embodiments. Referring to the flowchart of FIG. 5, the light source profile may be measured by placing a calibration pattern in front of the capture device 20 in step 210. The pattern is placed at a known angle relative to the capture device, such as for example perpendicular to the capture device. The calibration pattern may be an object having a flat surface with known albedo, ρ₀, which is positioned facing the capture device 20. In one example, the calibration pattern may be white, having a high albedo of ρ₀≧0.9, though it may have other albedos in further embodiments. The calibration pattern is also chosen with a surface to be measured that is rough enough so as not to produce specular highlights (discussed above), which can otherwise prevent accurate albedo measurements.

Where there are multiple IR light components 24 used, the contribution from the multiple IR light components 24 may be negated save for one IR light component being calibrated in step 214. The contributions from non-calibrated IR light components may be negated by turning them off, covering them with an opaque material, or negating their contribution in software.

In step 218, the capture device records the 3-D point cloud of the captured scene. As noted above, the datum delivered by the capture device 20 may be a 4-tuple (\vec{x}, g), consisting of the 3-D point \vec{x}=(x, y, z) and its active brightness value g.

In step 220, each point \vec{x} in the point cloud may be transformed into spherical coordinates:

$$spherical ( {x}^{->} ) = {( \begin{matrix}θ \\ ϕ\end{matrix} )}^{T} = {( \begin{matrix}{tan}^{- 1} ( \frac{y}{x} ) \\ {tan}^{- 1} \sqrt{z / ( {x}^{2} + {y}^{2} )}\end{matrix} )}^{T} . \qquad ( 8 )$$

From equations (1) and (2), the i^{th} light source's profile cᵢ(θ, φ) may be calibrated in step 222 as:

$${c}_{i} ( θ , ϕ ) = g \cdot \frac{{‖ {x}^{->} - {{l}^{->}}_{l} ‖}^{2}}{p \cdot cos {θ}_{i}} \qquad ( 9 )$$

This procedure may be repeated (step 226) for each light source, to yield functions c₁(θ, φ), . . . , cₙ(θ, φ). After calibration, the constant c₁ in equation (7) may be given for a scene point \vec{x} as:

cᵢ(spherical(\vec{x}−lᵢ)) (10)

FIG. 6 is an illustration of a sample light source profile 320 which may be obtained from imaging a calibration pattern as described above.

In order to speed computations using the light source profile cᵢ(θ,φ), the values for cᵢ(θ,φ) may be indexed into a look-up table and stored as a 2-D array in step 228.

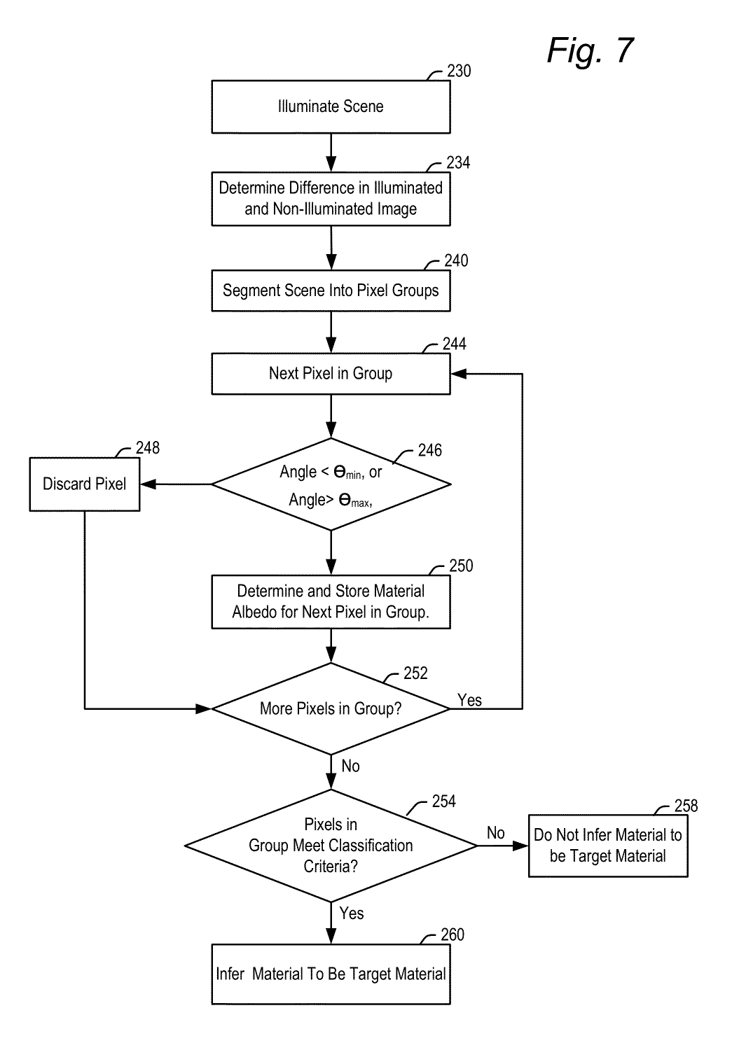

FIG. 7 illustrates operation of one embodiment of the classifier engine 192 to identify material captured by capture device 20. In embodiments, the classifier engine 192 is seeking to identify a specific target material, which in this example may be human skin, such as for example on a hand, face or other portions of the user's body not covered by clothing. As explained below, the classification engine may classify other target materials in further embodiments.

Data has shown that skin albedo values range from about 0.46 for dark skinned individuals to 0.66 for light skinned individuals for an incident light wavelength of 850 nm. Therefore, in one embodiment, pixel albedo values may be examined, and albedo values outside of the range 0.46 to 0.66 may be ruled out as skin. It is understood that the albedo values used as the lower and upper limits may vary above and/or below 0.46 and 0.66 in further embodiments. As set forth below, in a further embodiment, a system 10 may be trained for the specific albedo values of one or more users, to improve the ability of the classifier engine 192 at detecting the skin of such users.

Steps 230 and 234 provide the scene map point cloud which may be determined as described above. In particular, the scene may be illuminated in step 230 by the one or more IR light components 24, and the active brightness values g for pixels in the scene may be determined by taking the difference between the illuminated image and non-illuminated image.

In embodiments, the scene map may be broken into a number of 3-D groups of pixels, and thereafter, a determination may be made by the classifier engine 192 whether each group of pixels contains the target material, such as for example the skin of a user. The size of the pixel groups may vary in different embodiments, but may for example comprise a generally cubic region of 1000 pixels. This may contain image data for a portion of a hand (where a user is near to the capture device 20), or for a whole hand (where a user is farther away from the capture device 20). The pixel groups may be larger or smaller than that, and in shapes other than cubic, in further embodiments. In further embodiments, the division of the scene map into groups may be omitted, and the scene map analyzed as a whole. Moreover, in embodiments described below, the classifier engine may work in combination with other software engines for identifying the position of a user's hands. In such embodiments, the classifier engine may operate on a group of pixels already identified as possibly including a user's hand, and the group of pixels may be customized to the shape already identified as the potential hand.

The scene map point cloud may be broken down into 3-D groups of pixels in step 240. In step 244, a group of pixels is examined by the classifier engine 192. As noted above, a Lambertian reflectance model may not operate correctly under specular reflection. As such, step 246 checks for albedo values resulting from a small angle of incidence θ between the incident light and surface normal (for example θₘᵢₙ=5 degrees, though it may be greater or lesser than this in further embodiments). If the angle of incidence is less than this, the pixel under investigation may be discarded in step 248.

Additionally, dermatology literature indicates that skin may change its reflective property if the angle of the incident light to the surface normal is high, for example 85 degrees or more, as light may then no longer be penetrating through the epidermis but is reflected on the surface. As such, step 246 may also check for albedo values resulting from a large angle of incidence B between the incident light and surface normal (for example θₘₐₓ=85 degrees, though it may be greater or lesser than this in further embodiments). If the angle of incidence is more than this, the pixel under investigation may be discarded in step 248.

Assuming an angle θ within a suitable range, the material albedo for the pixel under investigation may be determined and stored in step 250, for example using equation (3) for a single light source or equation (7) for multiple light sources as described above. In step 252, the classifier engine may check whether there are additional pixels in the group under consideration. If so, the classifier engine 192 returns to step 244 to consider the next pixel, and steps 246, 248, 250 and 252 may be repeated until there are no further pixels in the group to consider in step 252.

Once all pixels in the group have been considered and the albedo values determined for those in the applicable angle of incidence range, the classifier engine 192 may determine whether the pixels as a whole in the group meet the classification criteria for inferring the surface material is the target material, such as for example skin. In one embodiment, the classification criteria are as follows:

$$class ( {group}_{i} ) = \{ \begin{matrix}DONT\_KNOW & , numValidPoints ( {group}_{i} ) < {P}_{min} & \\ NO\_SKIN & , numValidPoints ( {group}_{i} ) \geq {P}_{min} & ⋂ \frac{numSkinPoints ( {group}_{i} )}{numValidPoints ( {group}_{i} )} < {F}_{min} \\ POTENTIAL\_SKIN & , otherwise & \end{matrix}$$

In the above rule, numValidPoints(groupᵢ) denotes the number of points, e.g., pixels, in a group after discarding those with surface angles θ outside the interval [θₘᵢₙ, θₘₐₓ]. numSkinPoints(groupᵢ) is the number of valid points falling in the skin albedo interval. As noted above, in one embodiment, the skin albedo interval may be between 0.46 and 0.66, though it may have other limits in further embodiments.

In one embodiment, Pₘᵢₙ may be 150 pixels. Thus, if albedo values for less than 150 pixels exist in the group (either because the group was initially small, or because points were discarded for having incident angles outside of the applicable range), the classifier engine 192 returns an inconclusive determination (e.g.,“DON'T_KNOW”) for that group of pixels, and the surface material from which the group of pixels comes is not inferred to be the target material (e.g., human skin) in step 258. It is understood that the value for Pₘᵢₙ may be more or less than 150 pixels in further embodiments.

Assuming the number of valid pixels is more than Pₘᵢₙ, the classifier engine 192 examines the ratio of pixels within the predetermined skin albedo range to the total number of valid pixels. If the ratio is smaller than Fₘᵢₙ, the classifier engine 192 determines that the group of pixels under consideration is not the target material (e.g., human skin) in step 258. In one embodiment, Fₘᵢₙ may be 0.33, however, Fₘᵢₙ may be greater or lesser than 0.33 in further embodiments.

Assuming the number of valid pixels is more than Pₘᵢₙ, and assuming the ratio of pixels within the predetermined skin albedo range to the number of valid pixels is not less than Fₘᵢₙ, the classifier engine 192 may infer that the group of pixels under consideration is of the target material (e.g., skin) in step 260. Thereafter, the classifier engine may cease operation, or it may consider a further group of pixels as described above.

In embodiments described above where the target material to be detected is skin, a range of 0.46 to 0.66 may be used, which range may cover all human skin types. However, in further embodiments, the skin albedo interval can be further constrained and made smaller by considering a particular person instead of all of humanity. The albedo for a single person typically has a fairly small variance. Thus, in this embodiment, the classifier engine 192 uses a more narrow albedo interval in step 254 when determining whether pixels in the group meet the classification criteria. The result is that, if a group of pixels meets the criteria described above in step 254, there is a stronger inference in this embodiment that the group of pixels is, in fact, skin such as the hand of the user.

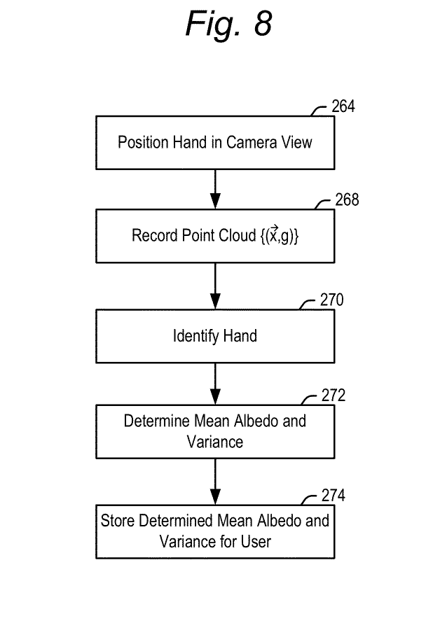

FIG. 8 is a flowchart for the training of the system 10 to learn and store the skin albedo for one or more users. In step 264, the system prompts the user with audio and or visual cues to position his/her hand in view of the capture device 20. As a user's palms may have less pigmentation than other areas of the user's skin, the user may show a back of his/her hand to the capture device. However, a user may alternatively or additionally show his/her palm.

In step 268, the system 10 records a scene map point cloud as described above. In step 270, the system may identify the user's hand. This may be done a variety of ways, including by albedo as described above and/or by other schemes described below. In step 272, the system may determine a mean albedo value, μ, for the user's skin, and a variance, σ², for the user's skin in step 272. These values may be stored in step 274. Thereafter, when performing the step 254 to determine whether pixels in the group meet the classification criteria, the system can use an interval of the mean μ±some multiple of sigma (k·σ). In one embodiment, the multiple may be 2.5 σ, but the multiple may be greater or smaller than that in further embodiments.

In this embodiment having stored user-constrained albedo values, not only can these values be used for a stronger inference that a group of pixels shows the user's skin, but this embodiment may also assist in differentiating and identifying different users. In particular, a number of users may go through the teaching routine shown in FIG. 8 so that the user-constrained albedo values for a number of users are stored. Thereafter, when a user interacts with the system, the classifier engine can compare the obtained albedo values to those stored in memory. This may assist in identifying which user is interacting with the system.

In embodiments described above, the classifier engine 192 may operate as a standalone software engine for identifying a user's skin. This information may be useful by itself in differentiating and tracking a user's hands in the FOV. In a further embodiment, the classifier engine 192 may be one of several routines which are applied to identify and track body parts. As an example, U.S. patent application Ser. No. 13/277,011, entitled, “System for Finger Recognition and Tracking,” filed Oct. 19, 2011 (“the '011 Application”) discloses several software engines for differentiating and tracking hands and fingers in different poses. That application is incorporated by reference herein in its entirety. As disclosed in the '011 Application, a skeletal recognition engine may be used to identify a user's skeleton. Knowing the position of the arms, the position of the hands can be narrowed within the FOV. Thereafter, an image segmentation engine and a descriptor extraction engine may apply various algorithmic tests for further identifying hand when in different poses.

The classifier engine 192 as described herein may augment and supplement the identification schemes set forth in the '011 Application. For example, a difficult detection scenario is posed when a user's hand is lying against another object, such as the user's chest, or engaged with another object. The classifier engine 192 using albedo values may be useful in differentiating a hand from background and other objects in such a scenario. The classifier engine 192 may be used in such a scheme as the primary grounds for identifying that an object is or is not a hand. Alternatively, it may be used to bolster (or detract from) the likelihood that an object may be identified as a hand.

In the embodiments described above, the classifier engine 192 has been described in terms of inferring whether a group of pixels or a discerned object is a hand. In further embodiments, the system may be used to identify skin and infer the identification of other parts of the user's body, such as for example the user's face, or exposed skin on the user's arms, legs or torso. In further embodiments, the target material sought to be identified may be something other than skin. The albedo values for a great many objects are well-known or may be computed, such as for example different types of wood, and low-reflectance metals or plastics (where specular reflection can be avoided). The present system may use any of these as target materials to be identified by the classifier engine. Thus, the present technology may be used to identify various objects which may appear in the FOV, either as fixed objects, or objects which are manipulated by the user, for example as part of interaction with a gaming or other application.

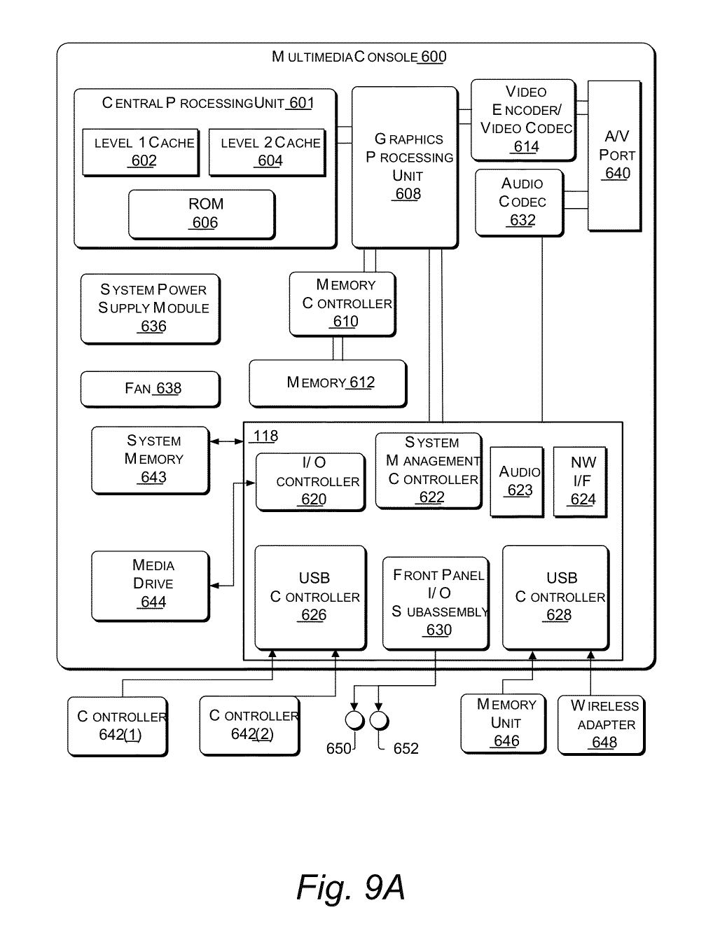

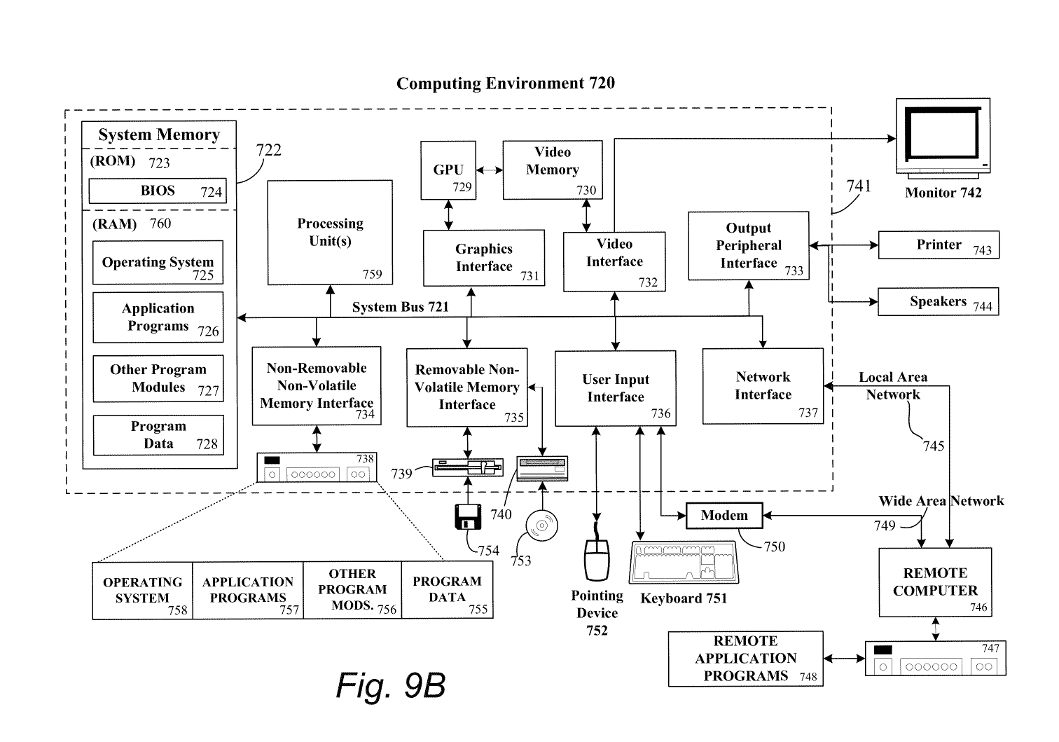

FIG. 9A illustrates an example embodiment of a computing environment that may be used to interpret one or more positions and motions of a user in a target recognition, analysis, and tracking system. The computing environment such as the computing environment 12 described above with respect to FIGS. 1A-2 may be a multimedia console 600, such as a gaming console. As shown in FIG. 9A, the multimedia console 600 has a central processing unit (CPU) 601 having a level 1 cache 602, a level 2 cache 604, and a flash ROM 606. The level 1 cache 602 and a level 2 cache 604 temporarily store data and hence reduce the number of memory access cycles, thereby improving processing speed and throughput. The CPU 601 may be provided having more than one core, and thus, additional level 1 and level 2 caches 602 and 604. The flash ROM 606 may store executable code that is loaded during an initial phase of a boot process when the multimedia console 600 is powered ON.

A graphics processing unit (GPU) 608 and a video encoder/video codec (coder/decoder) 614 form a video processing pipeline for high speed and high resolution graphics processing. Data is carried from the GPU 608 to the video encoder/video codec 614 via a bus. The video processing pipeline outputs data to an A/V (audio/video) port 640 for transmission to a television or other display. A memory controller 610 is connected to the GPU 608 to facilitate processor access to various types of memory 612, such as, but not limited to, a RAM.

The multimedia console 600 includes an I/O controller 620, a system management controller 622, an audio processing unit 623, a network interface controller 624, a first USB host controller 626, a second USB host controller 628 and a front panel I/O subassembly 630 that are preferably implemented on a module 618. The USB controllers 626 and 628 serve as hosts for peripheral controllers 642(1)-642(2), a wireless adapter 648, and an external memory device 646 (e.g., flash memory, external CD/DVD ROM drive, removable media, etc.). The network interface 624 and/or wireless adapter 648 provide access to a network (e.g., the Internet, home network, etc.) and may be any of a wide variety of various wired or wireless adapter components including an Ethernet card, a modem, a Bluetooth module, a cable modem, and the like.

System memory 643 is provided to store application data that is loaded during the boot process. A media drive 644 is provided and may comprise a DVD/CD drive, hard drive, or other removable media drive, etc. The media drive 644 may be internal or external to the multimedia console 600. Application data may be accessed via the media drive 644 for execution, playback, etc. by the multimedia console 600. The media drive 644 is connected to the I/O controller 620 via a bus, such as a Serial ATA bus or other high speed connection (e.g., IEEE 1394).

The system management controller 622 provides a variety of service functions related to assuring availability of the multimedia console 600. The audio processing unit 623 and an audio codec 632 form a corresponding audio processing pipeline with high fidelity and stereo processing. Audio data is carried between the audio processing unit 623 and the audio codec 632 via a communication link. The audio processing pipeline outputs data to the A/V port 640 for reproduction by an external audio player or device having audio capabilities.

The front panel I/O subassembly 630 supports the functionality of the power button 650 and the eject button 652, as well as any LEDs (light emitting diodes) or other indicators exposed on the outer surface of the multimedia console 600. A system power supply module 636 provides power to the components of the multimedia console 600. A fan 638 cools the circuitry within the multimedia console 600.

The CPU 601, GPU 608, memory controller 610, and various other components within the multimedia console 600 are interconnected via one or more buses, including serial and parallel buses, a memory bus, a peripheral bus, and a processor or local bus using any of a variety of bus architectures. By way of example, such architectures can include a Peripheral Component Interconnects (PCI) bus, PCI-Express bus, etc.

When the multimedia console 600 is powered ON, application data may be loaded from the system memory 643 into memory 612 and/or caches 602, 604 and executed on the CPU 601. The application may present a graphical user interface that provides a consistent user experience when navigating to different media types available on the multimedia console 600. In operation, applications and/or other media contained within the media drive 644 may be launched or played from the media drive 644 to provide additional functionalities to the multimedia console 600.

The multimedia console 600 may be operated as a standalone system by simply connecting the system to a television or other display. In this standalone mode, the multimedia console 600 allows one or more users to interact with the system, watch movies, or listen to music. However, with the integration of broadband connectivity made available through the network interface 624 or the wireless adapter 648, the multimedia console 600 may further be operated as a participant in a larger network community.

When the multimedia console 600 is powered ON, a set amount of hardware resources are reserved for system use by the multimedia console operating system. These resources may include a reservation of memory (e.g., 16 MB), CPU and GPU cycles (e.g., 5%), networking bandwidth (e.g., 8 kbs), etc. Because these resources are reserved at system boot time, the reserved resources do not exist from the application's view.

In particular, the memory reservation preferably is large enough to contain the launch kernel, concurrent system applications and drivers. The CPU reservation is preferably constant such that if the reserved CPU usage is not used by the system applications, an idle thread will consume any unused cycles.

With regard to the GPU reservation, lightweight messages generated by the system applications (e.g., popups) are displayed by using a GPU interrupt to schedule code to render popup into an overlay. The amount of memory used for an overlay depends on the overlay area size and the overlay preferably scales with screen resolution. Where a full user interface is used by the concurrent system application, it is preferable to use a resolution independent of the application resolution. A scaler may be used to set this resolution such that the need to change frequency and cause a TV resynch is eliminated.

After the multimedia console 600 boots and system resources are reserved, concurrent system applications execute to provide system functionalities. The system functionalities are encapsulated in a set of system applications that execute within the reserved system resources described above. The operating system kernel identifies threads that are system application threads versus gaming application threads. The system applications are preferably scheduled to run on the CPU 601 at predetermined times and intervals in order to provide a consistent system resource view to the application. The scheduling is to minimize cache disruption for the gaming application running on the console.

When a concurrent system application requires audio, audio processing is scheduled asynchronously to the gaming application due to time sensitivity. A multimedia console application manager (described below) controls the gaming application audio level (e.g., mute, attenuate) when system applications are active.

Input devices (e.g., controllers 642(1) and 642(2)) are shared by gaming applications and system applications. The input devices are not reserved resources, but are to be switched between system applications and the gaming application such that each will have a focus of the device. The application manager preferably controls the switching of input stream, without knowledge of the gaming application's knowledge and a driver maintains state information regarding focus switches. The cameras 26, 28 and capture device 20 may define additional input devices for the console 600.

FIG. 9B illustrates another example embodiment of a computing environment 720 that may be the computing environment 12 shown in FIGS. 1A-2 used to interpret one or more positions and motions in a target recognition, analysis, and tracking system. The computing system environment 720 is only one example of a suitable computing environment and is not intended to suggest any limitation as to the scope of use or functionality of the presently disclosed subject matter. Neither should the computing environment 720 be interpreted as having any dependency or requirement relating to any one or combination of components illustrated in the Exemplary operating environment 720. In some embodiments, the various depicted computing elements may include circuitry configured to instantiate specific aspects of the present disclosure. For example, the term circuitry used in the disclosure can include specialized hardware components configured to perform function(s) by firmware or switches. In other example embodiments, the term circuitry can include a general purpose processing unit, memory, etc., configured by software instructions that embody logic operable to perform function(s). In example embodiments where circuitry includes a combination of hardware and software, an implementer may write source code embodying logic and the source code can be compiled into machine readable code that can be processed by the general purpose processing unit. Since one skilled in the art can appreciate that the state of the art has evolved to a point where there is little difference between hardware, software, or a combination of hardware/software, the selection of hardware versus software to effectuate specific functions is a design choice left to an implementer. More specifically, one of skill in the art can appreciate that a software process can be transformed into an equivalent hardware structure, and a hardware structure can itself be transformed into an equivalent software process. Thus, the selection of a hardware implementation versus a software implementation is one of design choice and left to the implementer.

In FIG. 9B, the computing environment 720 comprises a computer 741, which typically includes a variety of computer readable media. Computer readable media can be any available media that can be accessed by computer 741 and includes both volatile and nonvolatile media, removable and non-removable media. The system memory 722 includes computer storage media in the form of volatile and/or nonvolatile memory such as ROM 723 and RAM 760. A basic input/output system 724 (BIOS), containing the basic routines that help to transfer information between elements within computer 741, such as during start-up, is typically stored in ROM 723. RAM 760 typically contains data and/or program modules that are immediately accessible to and/or presently being operated on by processing unit 759. By way of example, and not limitation, FIG. 9B illustrates operating system 725, application programs 726, other program modules 727, and program data 728. FIG. 9B further includes a graphics processor unit (GPU) 729 having an associated video memory 730 for high speed and high resolution graphics processing and storage. The GPU 729 may be connected to the system bus 721 through a graphics interface 731.

The computer 741 may also include other removable/non-removable, volatile/nonvolatile computer storage media. By way of example only, FIG. 9B illustrates a hard disk drive 738 that reads from or writes to non-removable, nonvolatile magnetic media, a magnetic disk drive 739 that reads from or writes to a removable, nonvolatile magnetic disk 754, and an optical disk drive 740 that reads from or writes to a removable, nonvolatile optical disk 753 such as a CD ROM or other optical media. Other removable/non-removable, volatile/nonvolatile computer storage media that can be used in the Exemplary operating environment include, but are not limited to, magnetic tape cassettes, flash memory cards, digital versatile disks, digital video tape, solid state RAM, solid state ROM, and the like. The hard disk drive 738 is typically connected to the system bus 721 through a non-removable memory interface such as interface 734, and magnetic disk drive 739 and optical disk drive 740 are typically connected to the system bus 721 by a removable memory interface, such as interface 735.

The drives and their associated computer storage media discussed above and illustrated in FIG. 9B, provide storage of computer readable instructions, data structures, program modules and other data for the computer 741. In FIG. 9B, for example, hard disk drive 738 is illustrated as storing operating system 758, application programs 757, other program modules 756, and program data 755. Note that these components can either be the same as or different from operating system 725, application programs 726, other program modules 727, and program data 728. Operating system 758, application programs 757, other program modules 756, and program data 755 are given different numbers here to illustrate that, at a minimum, they are different copies. A user may enter commands and information into the computer 741 through input devices such as a keyboard 751 and a pointing device 752, commonly referred to as a mouse, trackball or touch pad. Other input devices (not shown) may include a microphone, joystick, game pad, satellite dish, scanner, or the like. These and other input devices are often connected to the processing unit 759 through a user input interface 736 that is coupled to the system bus, but may be connected by other interface and bus structures, such as a parallel port, game port or a universal serial bus (USB). The cameras 26, 28 and capture device 20 may define additional input devices for the console 700. A monitor 742 or other type of display device is also connected to the system bus 721 via an interface, such as a video interface 732. In addition to the monitor, computers may also include other peripheral output devices such as speakers 744 and printer 743, which may be connected through an output peripheral interface 733.

The computer 741 may operate in a networked environment using logical connections to one or more remote computers, such as a remote computer 746. The remote computer 746 may be a personal computer, a server, a router, a network PC, a peer device or other common network node, and typically includes many or all of the elements described above relative to the computer 741, although a memory storage device 747 has been illustrated in FIG. 9B. The logical connections depicted in FIG. 9B include a local area network (LAN) 745 and a wide area network (WAN) 749, but may also include other networks. Such networking environments are commonplace in offices, enterprise-wide computer networks, intranets and the Internet.

When used in a LAN networking environment, the computer 741 is connected to the LAN 745 through a network interface or adapter 737. When used in a WAN networking environment, the computer 741 typically includes a modem 750 or other means for establishing communications over the WAN 749, such as the Internet. The modem 750, which may be internal or external, may be connected to the system bus 721 via the user input interface 736, or other appropriate mechanism. In a networked environment, program modules depicted relative to the computer 741, or portions thereof, may be stored in the remote memory storage device. By way of example, and not limitation, FIG. 9B illustrates remote application programs 748 as residing on memory device 747. It will be appreciated that the network connections shown are Exemplary and other means of establishing a communications link between the computers may be used.

The foregoing detailed description of the inventive system has been presented for purposes of illustration and description. It is not intended to be exhaustive or to limit the inventive system to the precise form disclosed. Many modifications and variations are possible in light of the above teaching. The described embodiments were chosen in order to best explain the principles of the inventive system and its practical application to thereby enable others skilled in the art to best utilize the inventive system in various embodiments and with various modifications as are suited to the particular use contemplated. It is intended that the scope of the inventive system be defined by the claims appended hereto.

What is claimed:

1. A method for identifying a surface material, comprising:
(a) capturing position data representing a three dimensional depth map of the surface material;
(b) measuring an amount of light incident on the surface material; and
(c) determining albedo values, from the data captured in said step (a) and light measured in said step (b), at points on the surface material for comparison against known albedo values to identify the surface material.

2. The method of claim 1, wherein the known albedo values include a range of known albedo values for a predefined target material, the method further comprising the step (d) of inferring whether or not the surface material is the predefined target material.

3. The method of claim 2, wherein the inference of said step (d) is based at least in part on a number of points determined in said step (c) to have albedo values falling with the range of the known albedo values for the predefined target material.

4. The method of claim 1, wherein the known albedo values include known albedo values for a plurality of predefined target materials, the method further comprising the step (e) of inferring whether or not the surface material is one of the plurality of predefined target materials.

5. A method for identifying whether a surface material is human skin, comprising:
(a) capturing an image of a field of view including the surface material;
(b) generating a depth map from the captured field of view, the depth map including three-dimensional coordinates of points on the surface material;
(c) determining an amount of light incident on the surface material;
(d) determining albedo values at points on the surface material from the depth map generated in said step (b) and the amount of incident light determined in said step (c);
(e) comparing the albedo values determined in said step (d) against a range of known albedo values for human skin; and
(f) drawing an inference as to whether the surface material is human skin based at least in part on a number of points on the surface material having albedo values within the range of albedo values for human skin.

6. The method of claim 5, wherein said step (a) of capturing an image of a field of view including the surface material comprises the steps of emitting light from a light component and capturing the light reflected back by an image capture device.

7. The method of claim 6, further comprising the step of calibrating the light component prior to said step (c) to determine an amount of light emitted by the light component.

8. The method of claim 7, said step of calibrating the light component comprising the step of shining light from the light component on a test pattern having a predefined albedo and capturing light reflected back from the test pattern in the image capture component.

9. The method of claim 5, said step (e) of comparing the albedo values determined in said step (d) against a range of known albedo values for human skin comprising the step of comparing the albedo values determined in said step (d) against the range of known albedo values for human skin across all humans.

10. The method of claim 5, said step (e) of comparing the albedo values determined in said step (d) against a range of known albedo values for human skin comprising the step of comparing the albedo values determined in said step (d) against the range of known albedo values for skin of a particular person.

11. The method of claim 10, further comprising the step receiving information from the particular person to determine and store the range of known albedo values for skin of the particular person.

12. The method of claim 5, further comprising the step of dividing the depth map into groups of pixels, said step (f) comprising the step of drawing an inference as to whether a group of pixels including image data representing human skin based at least in part on a number of points in the group of pixels having albedo values within the range of albedo values for human skin.

13. The method of claim 5, step (c) of determining an amount of light incident on the surface material comprising the step of including upper and lower boundaries on estimated reflectivity values used in determining the amount of incident light.

14. One or more processor readable storage devices having processor readable code embodied on said processor readable storage devices, said processor readable code for programming one or more processors to perform a method for identifying whether a surface material is a target material, comprising:
(a) capturing an image from of a field of view including the surface material;
(b) generating a depth map from the captured field of view, the depth map including three-dimensional coordinates of points on the surface material;
(c) determining an amount of light incident on the surface material;
(d) determining albedo values at points on the surface material from the depth map generated in said step (b) and the amount of incident light determined in said step (c);
(e) applying classification criteria to the points on the surface material for which albedo values have been determined in said step (d), the classification criteria returning an indication that: i) it is undetermined whether the points on the surface material are the target material, ii) it is determined that the points on the surface material are not the target material, or iii) it is inferred that the points on the surface are the target material.

15. The method recited in claim 14, wherein the target material is human skin.

16. The method recited in claim 15, wherein said step (e) of applying classification criteria to the points on the surface material comprise the step of comparing how many points on the surface material fall within the albedo interval for all humans.

17. The method recited in claim 15, wherein said step (e) of applying classification criteria to the points on the surface material comprise the step of comparing how many points on the surface material fall within the albedo interval for a particular person.

18. The method recited in claim 15, wherein said step (e) of applying classification criteria to the points on the surface material comprises returning an indication that it is undetermined whether the points on the surface material are the target material where albedo values for less than a predetermined number of points have been determined in said step (d).

19. The method recited in claim 18, wherein step (e) of applying classification criteria to the points on the surface material comprises returning an indication that it is determined that the points on the surface material are not the target material where a ratio of the points having albedo within a predefined albedo interval for skin to the overall number of points for which albedo was determined in said step (d) is less than a predefined ratio.

20. The method of claim 19, wherein said step (e) of applying classification criteria to the points on the surface material comprises returning an indication that it is inferred that that the points on the surface are skin where albedo values for greater than a predetermined number of points has been determined, and the ratio of the points having albedo within a predefined albedo interval for skin to the overall number of points for which albedo was determined in said step (d) is higher than the predefined ratio.
